(19) United States
(12) Patent Application Publication
(10) Pub. No.: US 2010/0182682 A1
(43) Pub. Date: Jul. 22, 2010

(54) Annulus Illuminator of microscope

(76) Inventors: Yao-Chang LEE, Hsinchu (TW); Pei-Yu Huang, Jinhu Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,145

(22) Filed: Apr. 30, 2009

(30) Foreign Application Priority Data
Jan. 20, 2009 (TW) 98201106

(51) Int. Cl. G02B 21/14

(52) U.S. Cl. 359/387

(57) ABSTRACT

An annulus illuminator of microscope is provided. The collimated light pipe produced by a pair of convex and concave cone mirrors of this illuminator provides illumination of darkfield microscopy. Sliding the convex cone mirror along the coaxial track of the cone mirror pair may continuously change the diameter of the collimated light pipe. Furthermore, this invention provides illumination of brightfield microscopy. A 45° rod-mirror is directly attached to the extension rod of the convex cone mirror for transmitting light from the same or an alternative light source of the microscope. Therefore, the present invention provides with dual-illumination function for both brightfield and darkfield microscopy and may be conveniently adapted to commercial microscopes.

### BACKGROUND OF THE INVENTION

1. Field of the Invention

The present invention relates to an illuminator of optical microscope, and particularly to an illuminator for enhancing image contrast and spatial resolution of darkfield microscopy.

2. Description of the Related Art

Darkfield microscopy has shown great promise for enhancement of image contrast and spatial resolution of the interior structure of a transparent or semiopaque object such as a biological cell.

To achieve darkfield microscopy, a collimated beam 113 is projected onto a field stop 121 according to a prior art as illustrated in FIG. 1. The collimated beam 113 passes through a field stop 121 to produce a collimated light pipe 115 that is then focused with a high numerical aperture (N.A) condenser 130 on the focal plane 116 at the sample slide 140. The darkfield image of sample is formed as light scattered 117 being collected by the objective 150; meanwhile, the condensed light pipe beam 118 is eliminated due to its large incident angle.

Referring to cross sections as illustrated in FIG. 2, which correspond to dotted line AA′ crossing the collimated beam 113, dotted line BB′ crossing the field stop 121, and dotted line CC′ crossing the collimated light pipe 115 produced by passing the collimated beam through a field stop 121 as shown in FIG. 1. Nevertheless, by use of a field stop 121 for producing a light pipe 115 loses most intensity of the incident light 113, which produces poor image contrast. Besides, for employing a laser as a light source in darkfield microscopy, beam expansion is usually required for matching the dimension of annulus of field stop, but serious loss of intensity is inevitable.

### SUMMARY OF THE INVENTION

The present invention is directed to an illuminator of microscope, which comprises a coaxially aligned convex and concave cone mirror pair of mirror surfaces against and parallel to each other. The cone mirror pair supplies a collimated light pipe of high intensity needed by darkfield microscopy as compared with a design using a conventional field stop, and the image contrast is thus improved. A laser light may be used as a light source without further beam extension, thereby enhancing image contrast and spatial resolution of images.

One embodiment provides an annulus illuminator of microscope including a convex cone mirror redirecting a first light beam perpendicularly into the convex cone mirror for producing a 360° illumination; and a concave cone mirror with a center hole allowing the first light beam to pass through bends rays of the 360° illumination at 90° for producing a collimated light pipe.

Moreover, an embodiment provides an illuminator of microscope further comprising a diameter-tuning device to vary the diameter of the collimated light pipe continuously by altering the relative positions of cone mirrors along a coaxial track.

Another embodiment provides an annulus illuminator of microscope with brightfield and darkfield options. For darkfield illumination, an optical element is arranged for redirecting the first light beam into the forward direction to be received by the convex cone mirror for the cone mirror pair to produce the collimated light pipe. For brightfield illumination, a 45° rod-mirror is attached at the other end of the convex cone mirror for 90° redirection of a second light beam from the light source of darkfield illumination or an alternative light source of brightfield illumination. Since the light source for brightfield and darkfield can be the same one or an alternative, the original design of the microscope may remain.

### BRIEF DESCRIPTION OF THE DRAWINGS

The objectives, the technical details and characteristics of the present invention can be more fully understood by reading the following description of the preferred embodiments, with reference made to the accompanying drawings, wherein:

FIG. 1 illustrates a conventional darkfield microscopy;

FIG. 2 illustrates the function of field stop for the conventional darkfield microscopy in FIG. 1;

FIG. 3 illustrates a light pipe producing part of an annulus illuminator of microscope based on one embodiment;

FIG. 4 illustrates a cross section of the annulus illuminator of microscope as shown in FIG. 3; and

FIG. 5 illustrates an annulus illuminator of microscope based on one embodiment.

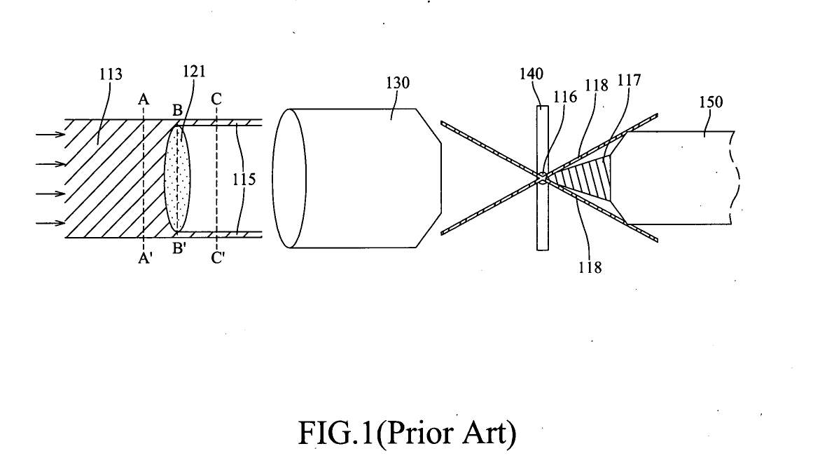

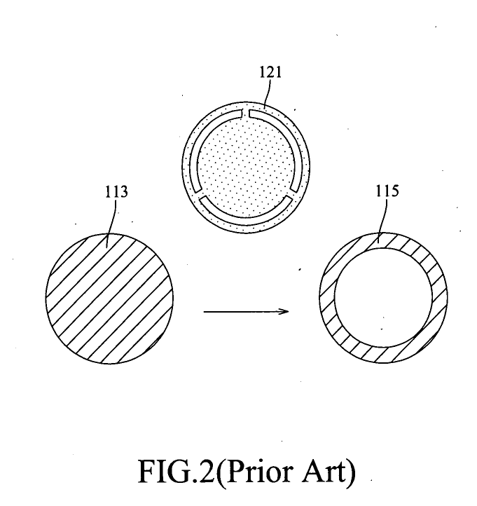

### DETAILED DESCRIPTION OF THE INVENTION

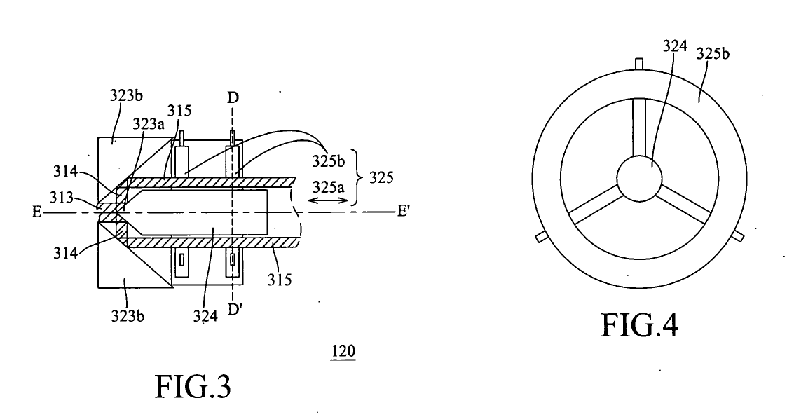

Based on one embodiment as illustrated in FIG. 3, an illuminator of microscope comprises a coaxially aligned cone mirror pair, a convex cone mirror 323a and a center-holed concave cone mirror 323b, of mirror surfaces facing against and positioned parallel to each other. A first light beam 313 passing through a center hole of a concave cone mirror 323b is redirected perpendicularly by the convex cone mirror 323a to the center-holed concave cone mirror 323b to produce a 360° illumination 314. Rays of the 360° illumination 314 are bent by the center-holed concave cone mirror 323b by 90° and becomes a collimated light pipe 315. Image contrast and resolution may be improved by using the collimated light pipe 315 of high intensity produced by the cone mirror pair rather than a conventional design using a field stop, which certainly causes a considerable intensity loss.

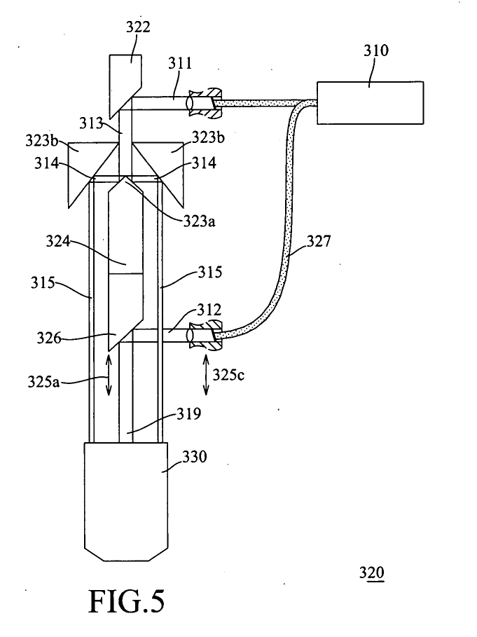

As illustrated in FIG. 3, one embodiment comprises a diameter-tuning device 325, which is mounted coaxially with the two cone mirrors (323a and 323b), to alter the relative positions of the two cone mirrors (323a and 323b) along the coaxial track EE′ for changing the diameter of the light pipe 315 continuously. The longer coaxial separation distance of the two cone mirrors (323a and 323b), the bigger the radius of the light pipe 315. The slide track 325a may attach to either one or both of the two cone mirrors (323a and 323b). In one embodiment, the slide track 325a is attached to an extension rod 324 extended from the circular end of the convex cone mirror 323a and aligned with the coaxial track EE′. In addition, in one embodiment, the diameter-tuning device 325 comprises at least one alignment annulus 325b, as illustrated in FIG. 4, for holding the extension rod 324 in order to align the concave cone mirror 323a to be coaxial to the convex cone mirror 323b.

Referring to FIG. 5, one embodiment of the annulus illuminator of microscope 320 serving both brightfield and darkfield illumination functions is provided. This embodiment includes a redirecting optical element 322 used by darkfield illumination such as a mirror or a right-angled prism for redirecting the first light beam along light path 311 to be along light path 313 parallel to the axial direction of the convex cone mirror 323a. Moreover, this embodiment also comprises a 45° rod-mirror 326 attached to the extension rod 324, which plays a role to redirect a second light beam along light path 312 to be along light path 319 for brightfield illumination. In this embodiment, the first light beam along light path 311 and the second light beam along light path 312 could be from the same light source 310 transmitted by fiber optics 327 or one of them could be from an alternative light source. Of course, a microscope with only the darkfield illumination function illustrated in this embodiment is also in the scope of the invention. For compensating the position difference caused by different diameter of light pipe being applied, the position of the entrance of transmitting second light beam 312 can be altered to fit the position of 45° rod-mirror 326 by sliding track 325c.

In summary, an annulus illuminator of microscope employing a cone mirror pair, one convex and one concave, to achieve producing an collimated light pipe of high intensity for darkfield microscopy. The embodiments may improve the utility rate of light source intensity, and be compatible with laser light sources, enhancing image contrast and spatial resolution, respectively. Sliding the convex cone mirror along the coaxial track towards or away from the concave cone mirror can continuously alter the diameter of the light pipe. Besides, this embodiment integrates both brightfield and darkfield illumination functions together, i.e., two-in-one illumination, by attaching a 45° rod-mirror to the extension rod of the convex cone mirror for transmitting light from the same or an alternative light source for darkfield illumination without modifying the original design of a conventional microscope.

The embodiments as described above demonstrate the technical contents and characteristics of the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. An annulus illuminator of microscope comprising:
a convex cone mirror redirecting a first light beam in a forward direction perpendicularly for producing a 360° illumination; and
a center-holed concave cone mirror, coaxially aligned with said convex cone mirror, bending rays of said 360° illumination at 90° for producing a collimated light pipe.

2. The annulus illuminator of microscope according to claim 1 wherein said center-holed concave cone mirror can be replaced with a center-holed hallow retroreflector which is assembled using at least three plane mirrors.

3. The annulus illuminator of microscope according to claim 1 further comprising a redirecting optical element concerning darkfield illumination for redirecting said first light beam from a light source into said forward direction.

4. The annulus illuminator of microscope according to claim 3 wherein said redirecting optical element is a mirror or a right-angled prism.

5. The annulus illuminator of microscope according to claim 3 further comprising a 45° rod-mirror concerning brightfield illumination for bending a second light beam from said light source or an alternative light source at 90° into said forward direction.

6. The annulus illuminator of microscope according to claim 1 further comprising a diameter-tuning device constructed on one or both of said convex cone mirror and said center-holed concave cone mirror for altering relative positions of said convex cone mirror and said center-holed concave cone mirror along a coaxial track.

7. The annulus illuminator of microscope according to claim 6 wherein said convex cone mirror is supported by an extension rod extended from the circular end of said convex cone mirror, and said extension rod is aligned to said coaxial track.

8. The annulus illuminator of microscope according to claim 7 wherein said diameter-tuning device comprises a slide track attached to said extension rod.

9. The annulus illuminator of microscope according to claim 7 wherein said diameter-tuning device further comprises at least one alignment annulus for holding said extension rod and aligning said convex cone mirror to be coaxial with said center-holed concave cone mirror.

10. The annulus illuminator of microscope according to claim 7 further comprising:
a redirecting optical element concerning darkfield illumination for redirecting said first light beam from a light source into said forward direction; and
a 45° rod-mirror concerning brightfield illumination, attaching to an end of said extension rod, reflecting a second light beam from said light source or an alternative light source into said forward direction.

11. The annulus illuminator of microscope according to claim 10 wherein said redirecting optical element is a mirror or a right-angled prism.
